(19) United States
(12) Patent Application Publication
(10) Pub. No.: US 2017/0171643 A1
(43) Pub. Date: Jun. 15, 2017

(54) METHOD AND ELECTRONIC DEVICE FOR DISPLAYING WATERMARK

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Qi ZHANG, Beijing (CN)

(21) Appl. No.: 15/242,340

(22) Filed: Aug. 19, 2016

Related U.S. Application Data
(63) Continuation of application No. PCT/CN2016/088472, filed on Jul. 4, 2016.

(30) Foreign Application Priority Data
Dec. 14, 2015 (CN) 201510923431.X

(51) Int. Cl. H04N 21/8358; H04N 21/6587; H04N 21/254; H04N 21/2387; H04N 21/235; H04N 21/234

(52) U.S. Cl. CPC H04N 21/8358; H04N 21/2353; H04N 21/23424; H04N 21/2541; H04N 21/2387; H04N 21/6587; H04L 67/42

(57) ABSTRACT

Aspects of the present disclosure are related to a method and an electronic device for displaying watermark applied to a player terminal. One illustrative method may include obtaining a video logo of a video being played currently; obtaining a target watermark corresponding to the video logo and watermark information of the target watermark from a preset server, the watermark information at least including: a watermark format and display information; and displaying the target watermark on a picture of the video being played currently according to the watermark information. According to various methods for displaying watermark, the watermark can be displayed normally without being affected by a stuck or paused video when the watermark is displayed, such that the user can still view the watermark information normally displayed even when the picture of the video is stopped.

### CROSS REFERENCE TO RELATED APPLICATIONS

This application is a continuation of International PCT Patent Application No. PCT/CN2016/088472, filed Jul. 4, 2016 (attached hereto as an Appendix), and claims benefit/priority of Chinese patent application No. 201510923431.X, filed with the State Intellectual Property Office of China on Dec. 14, 2015, all of which are incorporated herein by reference in entirety.

### BACKGROUND

Technical Field

The present disclosure relates to the field of video technique, more particularly, to methods and electronic devices for displaying watermark.

Description of Related Information

A video watermark refers to words, icon, logo, etc. shown at the top right corner or other position of a video when the video is played, the function of the video watermark is to declare and mark the copyright ownership of the video contents.

However, words or pictures are generally employed in the existing video watermark technique, generally such watermarks are embedded into images of video frames, such that when the video is stopped or stuck, a user may wait for the currently stopped picture or stopped watermark.

### OVERVIEW OF SOME ASPECTS

To overcome the problem existed in the related technique, the present disclosure provides a method and electronic device for displaying watermark.

According to a first aspect of the embodiments of the present disclosure, a method for displaying watermark is provided, the method is applied to a player terminal, and the method includes:

Obtaining a video logo of a video being played currently;

Obtaining a target watermark corresponding to the video logo and watermark information of the target watermark from a preset server, the watermark information at least including: a watermark format and display information; and

Displaying the target watermark on a picture of the video being played currently according to the watermark information.

According to a second aspect of the embodiments of the present disclosure, the embodiment of the present disclosure provides a non-volatile computer-readable storage medium stored with computer executable instructions, the computer executable instructions are configured to perform any one of the method for adjusting video subtitles described above in the disclosure.

According to a third aspect of the embodiments of the present disclosure, the embodiment of the present disclosure provides an electronic device, comprising: at least one processor; and a memory; wherein, the memory is communicably connected with the at least one processor for storing instructions executed by the at least one processor, the computer executable instructions are configured to perform any one of the method for adjusting video subtitles described above in the disclosure.

The technical schemes provided by the embodiments of the present disclosure may include the following advantageous effects.

According to the method provided by the embodiments of the present disclosure, a target watermark and display information corresponding to a video logo can be obtained according to the video logo when the video is played, and then the target watermark is displayed in an overlapping manner on a picture of the video while the video is played. In the embodiments of the present disclosure, because the watermark is mutually independent from video data, rather than embedded in the picture of the video, such that the watermark can still be obtained from a server even when the picture of the video is stuck or paused, and the watermark can be controlled to be displayed on the stuck or paused picture of the video.

Therefore, according to the method for displaying watermark provided by the embodiments of the present disclosure, watermark can be displayed normally without being affected by a stuck or pause video when the waterprint is displayed, such that the user can still watch watermark information displayed normally even when the picture of the video is stopped, thus the user's interest in waiting for video playing is improved, thereby increasing user's loyalty to the programme, and preventing the user from switching to other programs or channels while waiting.

Furthermore, the format such as GIF format, HTML5 format, audio format or link address format and the like may be employed as a watermark format displayed when the picture of the video is stuck or paused, rather than static picture such as words or logo and the like. Therefore, when the video is stuck or paused, the user can still enjoy a dynamic picture, music or Flash in the watermark, or interact with the watermark, for example, operate Flash games, access a link address to search or shopping and the like, thus the user's interest in waiting for video playing is greatly improved further.

It should be understood that, the above general description and detailed description below merely exemplary and explanatory, without limiting the present disclosure.

### BRIEF DESCRIPTION OF THE DRAWINGS

One or more embodiments are illustrated by way of examples, and not by limitation, in the figures of the accompanying drawings, wherein elements having the same reference numeral designations represent like elements throughout. The drawings are not to scale, unless otherwise disclosed.

FIG. 1 is a schematic flowchart of a method for displaying watermark provided by the embodiments of the present disclosure;

FIG. 2 is a schematic flowchart of step S102 in FIG. 1;

FIG. 3 is a schematic flowchart of step S103 in FIG. 1;

FIG. 4a is a schematic flowchart of another method for displaying watermark provided by the embodiments of the present disclosure;

FIG. 4b is a schematic flowchart of step S104 in FIG. 1;

FIG. 4c is another schematic flowchart of step S104 in FIG. 1;

FIG. 5 a structure schematic diagram of a device for displaying watermark provided by the embodiments of the present disclosure;

FIG. 6 is a structure schematic diagram of a watermark obtaining module in FIG. 5;

FIG. 7 is a structure schematic diagram of a displaying module in FIG. 5;

FIG. 8 is a structure schematic diagram of another device for displaying watermark provided by the embodiments of the present disclosure;

FIG. 9 is a structure schematic diagram of a stop play detecting module in FIG. 8;

FIG. 10 is another structure schematic diagram of a stop play detecting module in FIG. 8;

FIG. 11 is structure schematic diagram of an electronic device provided in the embodiments of the present disclosure.

### DETAILED DESCRIPTION OF ILLUSTRATIVE IMPLEMENTATIONS

Embodiments are illustrated in detail herein with examples indicated in drawings. When the following descriptions involve drawings, unless specially indicated, the same number in different drawings indicates the same or similar factor. The implementations described in the following embodiments do not represent all implementations consistent with the present disclosure. On the contrary, they are merely examples of devices and methods consistent with some aspects of the present disclosure, as expatiated in appended claims.

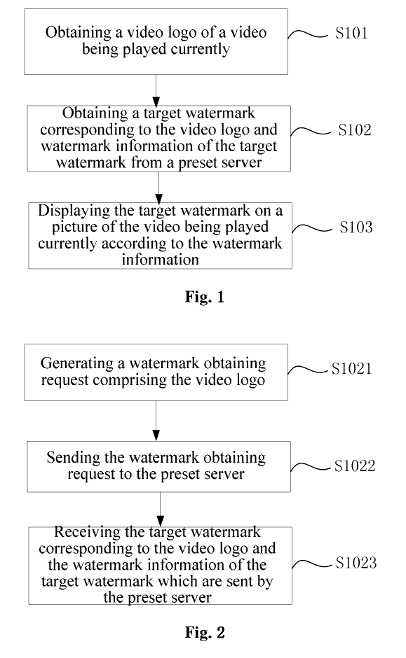

FIG. 1 is a flowchart of a method for displaying watermark illustrated according to an embodiment. As shown in FIG. 1, the method may include the following steps.

Step S101: a video logo of a video being played currently is obtained.

In the embodiments of the present disclosure, the video logo may be a name of entertainment programme, teleplay or movie, and may also be channel information of a video being played currently, such as CCTV6. No matter which type of video logo is, the object thereof is for understanding what the video being played currently is, thereby facilitating a setting of corresponding watermark according to the played video.

When the video logo is the name of entertainment programme, teleplay or movie, the video logo may be obtained by obtaining a playbill via a server, and may also be extracted from data of video frame. Furthermore, when the video logo is channel information, a channel number of the current channel may further be directly obtained from the local or the server.

Step S102: a target watermark corresponding to the video logo and watermark information of the target watermark are obtained from a preset server.

In the embodiments of the present disclosure, the watermark information may include: a watermark format and display information, wherein the watermark format may include one or more of GIF format, HTML5 format, audio format and link address format. In the embodiments of the present disclosure, the watermark format of a target watermark does not include static picture or logo. In these watermark formats, the GIF (Graphics Interchange Format) format is mainly used for displaying dynamic picture, the HTML5 format may display Flash or web game and the like to the user, the audio format may play songs or other music programmes to the user, and the link address may display some information associated with the vide to the user, for example, actor's blog and item purchasing links existing in video, etc.

The display information may include: a display position of the watermark, a time when the watermark displays, a duration of the watermark, and repetition times of the watermark. Display modes of the watermark can be conveniently controlled by the display information.

Step S103: the target watermark is displayed on a picture of the video being played currently according to the watermark information.

After a target watermark is obtained, the target watermark can be controlled to be displayed on a picture of the video being played currently by watermark information of the target watermark; and when the target watermark is displayed, the watermark information can be directly displayed in an overlapping manner on the picture of the video being played currently, such that the watermark and the video being played do not affect each other.

According to the method provided by the embodiments of the present disclosure, a target watermark and display information corresponding to a video logo can be obtained according to the video logo when the video is played, and then the target watermark is displayed in an overlapping manner on a picture of the video while the video is played. In embodiments of the disclosure, because the watermark is mutually independent from video data rather than embedded in the picture of the video, such the watermark can still be obtained from a server even when the picture of the video is stuck or paused, and controlled to be displayed on the stuck or paused picture of the video.

Therefore, according to the method for displaying watermark provided by the embodiments of the present disclosure, the watermark can be displayed normally without being affected by a stuck or pause video when the watermark is displayed, such that the user can still watch watermark information normally displayed even when the picture of the video is stopped, thus the user's interest in waiting for video playing is improved, thereby increasing user's loyalty to the programme, and preventing the user from switching to other programs or channels while waiting.

Furthermore, the format such as GIF format, HTML5 format, audio format or link address format and the like is employed as a watermark format displayed when the picture of the video is stuck or paused, rather than static picture such as words or logo and the like. Therefore, when the video is stuck or paused, the user can still enjoy a dynamic picture, music or Flash in the watermark, or interact with the watermark, for example, operate Flash games, access a link address to search or shopping and the like, thus the user's interest in waiting for video playing is greatly improved further.

In another embodiment of the present disclosure, as shown in FIG. 2, the step S102 in the embodiments shown in FIG. 1 may include the following steps.

Step S1021: a watermark obtaining request including the video logo is generated.

In the embodiments of the present disclosure, a TV may be provided with a processor, such that when the video is played, the processor can automatically generate watermark obtaining request when a logo of the video being played currently is obtained, the watermark obtaining request carries a video logo.

Furthermore, a request template may further be preset, such that when a watermark obtaining request is generated, the watermark obtaining request can be directly generated by adding the video logo to the preset request template, and certainly, the watermark obtaining request can also be automatically generated according to a preset protocol.

Step S1022: the watermark obtaining request is sent to the preset server.

A video player terminal refers to a TV connected to an optical fiber or connected to a cable TV network, thus in this step, the request can be sent to the server of operator via the optical fiber or the cable TV network.

Step S1023: the target watermark, corresponding to the video logo and watermark information of the target watermark which are sent by the preset server are received.

By the method provided by the embodiments of the present disclosure, the target watermark and watermark information corresponding to the video logo can be quickly obtained through interactions with the server when the video logo is obtained.

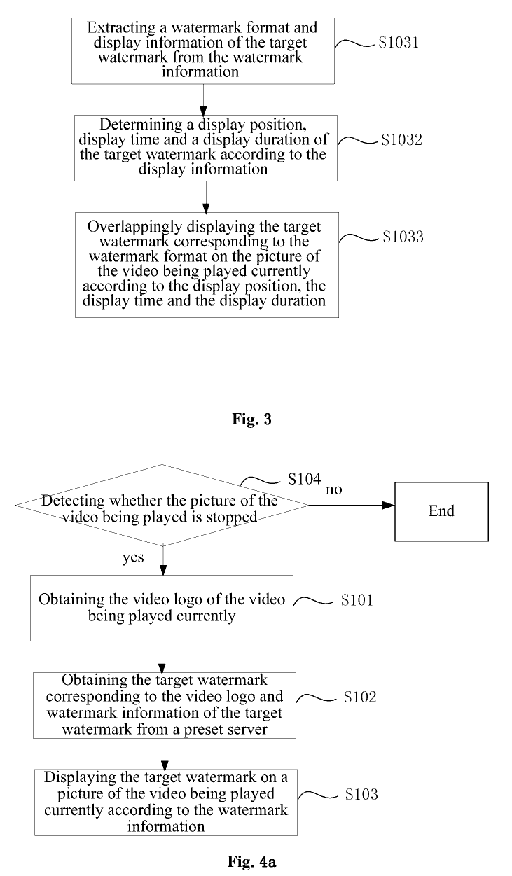

In another embodiment of the present disclosure, as shown in FIG. 3, the step S103 in the embodiments shown in FIG. 1 may include the following steps.

Step S1031: watermark format and display information of the target watermark are extracted from the watermark information.

Step S1032: a display position, display time and a display duration of the target watermark are determined according to the display information.

Step S1033: the target watermark corresponding to the watermark format is overlappingly displayed on the picture of the video being played currently according to the display position, the display time and the display duration.

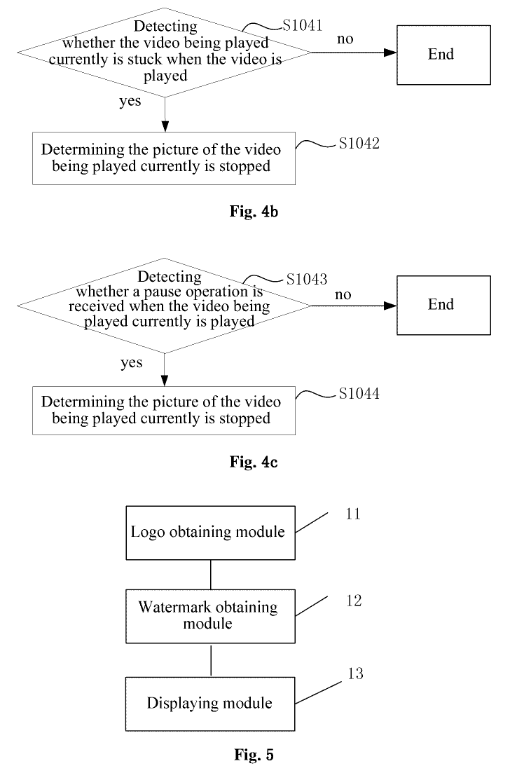

In another embodiment of the present disclosure, as shown in FIG. 4a, based on the embodiments shown in FIG. 1, the method may further include the following steps.

Step S104: whether the picture of the video being played currently is stopped or not is detected.

When whether the picture of a video being played currently is stopped or not is determined, in one or more embodiments of the present disclosure, as shown in FIG. 4a, the above step S104 may include the following steps.

Step S1041: whether the video being played currently is stuck or not is determined when the video is played.

If the video being played currently is stuck when the video is played, step S1042 is performed, otherwise the procedure is ended.

Step S1042: the picture of the video being played currently is determined to be stopped.

In another embodiment of the present disclosure, as shown in FIG. 4b, the above step S104 may include the following steps.

Step S1043: whether a pause operation is received or not is detected when the video being played currently is played.

If the video being played currently is stuck when the video is played, step S1044 is performed, otherwise the procedure is ended.

Step S1044: the picture of the video being played currently is determined to be stopped.

If the picture of the video being played currently is stopped, the above step S101 is performed, otherwise the procedure is ended. In other embodiments of the present disclosure, the step S104 may further be set in the step S102 and the step S103, in other words, a watermark and information related can be obtained in advance, but displayed only when the picture of the video is stopped.

According to the method provided by the embodiments of the present disclosure, a target watermark may not be displayed when a video is played normally, while the target watermark is displayed only when a picture of the video is detected to be stopped, such that in one aspect, affection on video quality caused by shading on the picture of the video by the watermark can be reduced when the video is played normally; and in another aspect, the user can quickly watch or operate the target watermark when the video cannot be watched.

FIG. 5 illustrates a device for displaying watermark provided by the embodiments of the present disclosure, which may be applied to player device such as a TV or computer, as shown in FIG. 5, the device may include: a logo obtaining module 11, a watermark obtaining module 12 and a displaying module 13.

The logo obtaining module 11 is configured to obtain a video logo of a video being played currently.

In the embodiments of the present disclosure, the video logo may be a name of entertainment programme, teleplay or movie, and may also be channel information of a video being played currently, such as CCTV6. No matter which type of the video logo is, the object thereof is for understanding what the video being played currently is, thereby facilitating a setting of corresponding watermark according to the played video.

When the video logo is a name of entertainment programme, teleplay or movie, the video logo may be obtained by obtaining a playbill via a server, and may also be extracted from data of video frame. Furthermore, when the video logo is channel information, a channel number of the current channel may further be directly obtained from the local or the server.

The watermark obtaining module 12 is configured to obtain a target watermark corresponding to the video logo and watermark information of the target watermark from a preset server.

In the embodiments of the present disclosure, watermark information may include: a watermark format and display information, wherein the watermark format may include one or more of GIF format, HTML5 format, audio format and link address format. In the embodiments of the present disclosure, the watermark format of a target watermark does not include static picture or logo. In these watermark formats, the GIF (Graphics Interchange Format) format is mainly used for displaying dynamic picture, the HTML5 format may display Flash or web game and the like to the user, the audio format may play songs or other music programs to the user, and the link address may display some information associated with the vide to the user, for example, actor's blog and item purchasing links existing in the video, etc.

The display information may include: a display position of the watermark, a time when the watermark is displayed, a duration of the watermark, and repetition times of the watermark. Display modes of the watermark can be conveniently controlled by the display information.

The displaying module 13 is configured to display the target watermark on a picture of the video being played currently according to the watermark information.

After a target watermark is obtained, the target watermark can be controlled to be displayed on a picture of the video being played currently by watermark information of the target watermark. The watermark information can be directly displayed in an overlapping manner on the picture of the video being played currently when the target watermark is displayed, such that the watermark and the video being played do not affected each other.

According to the method provided by the embodiments of the present disclosure, a target watermark and display information corresponding to a video logo can be obtained according to the video logo when the video is played, and then, the target watermark is displayed in an overlapping manner on a picture of the video while the video is played. In the embodiments of the present disclosure, because the watermark is mutually independent from video data, rather than embedded in the picture of the video, the watermark can still be obtained from a server even when the picture of the video is stuck or paused, and controlled to be displayed on the stuck or paused picture of the video.

Therefore, according to the device for displaying watermark provided by the embodiments of the present disclosure, the watermark can be displayed normally without being affected by a stuck or pause video when the watermark is displayed, such that the user can still watch watermark information normally displayed even when the picture of the video is stopped, thus the user's interest in waiting for video playing is improved, thereby increasing user's loyalty to the programme, and preventing the user from switching to other programs or channels while waiting.

Furthermore, the format such as GIF format, HTML5 format, audio format or link address format and the like is employed as a watermark format displayed when the picture of the video is stuck or paused, rather than static picture such as words or logo and the like, therefore, when the video is stuck or paused, the user can still enjoy dynamic picture, music or Flash in the watermark, or interact with the watermark, for example, operate Flash games, access a link address to search or shopping and the like, thus the user's interest in waiting for video playing is greatly improved further.

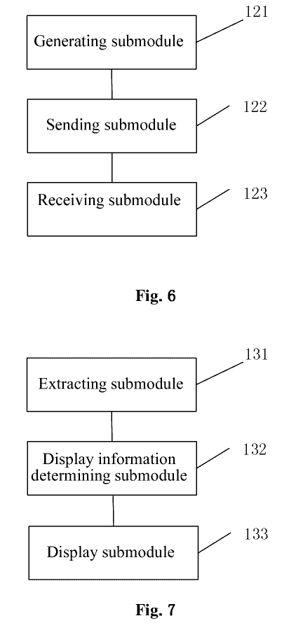

In an embodiment of the present disclosure, as shown in FIG. 6, the watermark obtaining module 12 may include: a generating submodule 121, a sending submodule 122, and a receiving submodule 123.

The generating submodule 121 is configured to generate a watermark obtaining request including the video logo.

In the embodiments of the present disclosure, a TV may be provided with a processor, as such, when the video is played, the processor may generate the watermark obtaining request when the logo of the video being played currently is obtained. The watermark obtaining request carries the video logo.

Furthermore, a request template may further be preset, such that when the watermark obtaining request is generated, the watermark obtaining request can be directly generated by adding the video logo to the preset request template, and certainly, the watermark obtaining request can also be automatically generated according to a preset protocol.

The sending submodule 122 is configured to send the watermark obtaining request to the preset server.

A video player terminal refers to a TV connected to an optical fiber or connected to a cable TV network, thus in this step, the request can be sent to the server of operator via the optical fiber or the cable TV network.

The receiving submodule 123 is configured to receive a target watermark corresponding to the video logo and watermark information of the target watermark which are sent by the preset server.

By the method provided by the embodiments of the present disclosure, the target watermark corresponding to the video logo and watermark information thereof can be quickly obtained through interactions with the server when the video logo is obtained.

In an embodiment of the present disclosure, as shown in FIG. 7, the displaying module 13 may include:

An extracting submodule 131 configured to extract a watermark format and display information of the target watermark from the watermark information;

A display information determining submodule 132 configured to determining a display position, display time, and a display duration of the target watermark according to the display information; and

A display submodule 133 configured to display the target watermark at the display position on the picture of the video being played currently according to the watermark format.

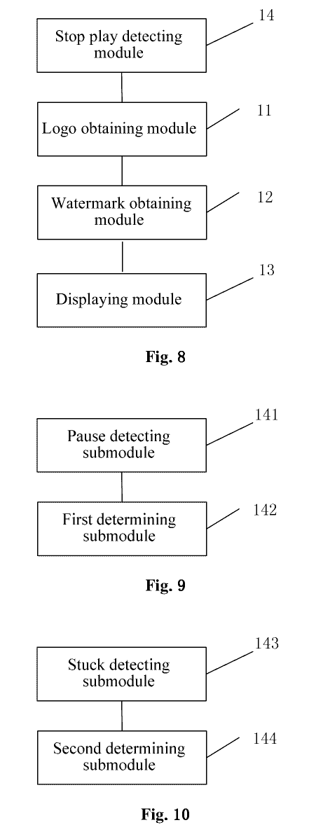

In another embodiment of the present disclosure, as shown in FIG. 8, the device may further include:

A stop play detecting module 14 configured to detect whether the picture of the video being played currently is stopped; and

The logo obtaining module 11 is further configured to obtain the video logo of the video being played currently if the picture of the video being played currently is stopped.

In another embodiment of the present disclosure, as shown in FIG. 9, the stop play detecting module 14 may include:

A pause detecting submodule 141 configured to detect whether a pause operation is received or not when the video being played currently is played; and

A first determining submodule 142 configured to determine the video being played currently to be stopped if the pause operation is received when the video being played currently is played.

In another embodiment of the present disclosure, as shown in FIG. 10, the stop play detecting module 14 may include:

A stuck detecting submodule 143 configured to detect whether the video being played currently is stuck when the video is played; and

A second determining submodule 144 configured to determine the video being played currently to be stopped if the video being played currently is stuck when the video is played.

According to the device provided by the embodiments of the present disclosure, a target watermark may not be displayed when a video is played normally, while the target watermark is displayed only when a picture of the video is detected to be stopped, such that in one aspect, affection on video quality caused by shading on the picture of the video from the watermark can be reduced when the video is played normally; and in another aspect, the user can quickly watch or operate the target watermark when the video cannot be watched.

The embodiments of the present disclosure further provide a non-volatile computer-readable storage medium, the non-volatile computer-readable storage medium is stored with computer executable instructions which are used to perform any of the embodiments described above of the method for displaying watermark.

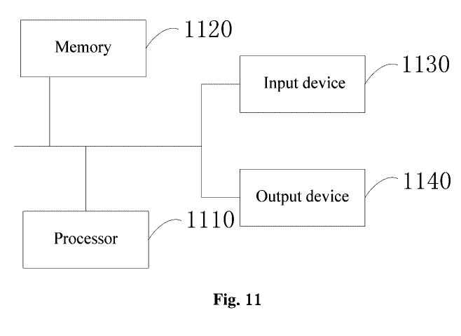

FIG. 11 is a schematic diagram of hardware structure of an electronic device used to perform the method for displaying watermark according to an embodiment of the present disclosure, as shown in FIG. 11, the device includes:

One or more processors 1110 and a memory 1120, FIG. 11 illustrates one processor 1110 as an example.

The device for the method for displaying watermark may further include an input device 1130 and an output device 1140.

The processor 1110, the memory 1120, the input device 1130 and the output device 1140 may be connected with each other through bus or other forms of connections. FIG. 11 illustrates bus connection as an example.

As a non-volatile computer readable storage medium, the memory 1120 may be configured to store non-volatile software program, non-volatile computer executable program and modules, such as program instructions/modules corresponding to the method for displaying watermark according to the embodiments of the disclosure (for example, the logo obtaining module 11, the watermark obtaining module 12 and the displaying module 13, as illustrated in FIG. 5. By executing the non-volatile software program, instructions and modules stored in the memory 1120, the processor 1110 may perform various functional applications of the server and data processing, that is, the method for displaying watermark according to the above mentioned embodiments.

The memory 1120 may include a program storage area and a data storage area, wherein, the program storage area may be stored with the operating system and applications which are needed by at least one functions, and the data storage area may be stored with data which is created according to use of the device for displaying watermark. Further, the memory 1120 may include a high-speed random access memory, and may further include non-volatile memory, such as at least one of disk memory device, flash memory device or other types of non-volatile solid state memory device. In some embodiments, optionally, the memory 1120 may include memory provided remotely from the processor 1110, and such remote memory may be connected with the device for displaying watermark through network connections, the examples of the network connections may include but not limited to internet, intranet, LAN (Local Area Network), mobile communication network or combinations thereof.

The input device 1130 may receive inputted number or character information, and generate key signal input related to the user settings and functional control of the device for displaying watermark. The output device 1140 may include a display device such as a display screen.

The above one or more modules may be stored in the memory 1120, when these modules are executed by the one or more processors 1110, the method for displaying watermark according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and include several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1.-18. (canceled)

19. A method for displaying watermarks, the method comprising:
at an electronic device:
obtaining a video logo of a video being played currently;
obtaining a target watermark corresponding to the video logo and watermark information of the target watermark from a preset server, the watermark information comprising a watermark format and display information; and
displaying the target watermark on a picture of the video being played currently according to the watermark information.

20. The method of claim 19, wherein the obtaining the target watermark corresponding to the video logo and the watermark information of the target watermark from the preset server comprises:
generating a watermark obtaining request comprising the video logo;
sending the watermark obtaining request to the preset server; and
receiving the target watermark corresponding to the video logo and the watermark information of the target watermark which are sent by the preset server.

21. The method according to claim 19, wherein the displaying the target watermark on the picture of the video being played currently comprises:
extracting the watermark format and the display information of the target watermark from the watermark information;
determining a display position, display time and a display duration of the target watermark according to the display information; and
displaying, in an overlapping manner, the target watermark corresponding to the watermark format on the picture of the video being played currently according to the display position, the display time and the display duration.

22. The method according to claim 19, wherein, the watermark format comprises: one or more of graphics interchange format GIF format, HTML5 format, audio format and link address format.

23. The method according to claim 19, further comprising:
detecting whether the picture of the video being played currently is stopped; and
executing the step of obtaining the video logo of the video being played currently if the picture of the video being played currently is stopped.

24. The method according to claim 23, wherein, the determining whether the picture of the video being played currently is stopped comprises:
detecting whether a pause operation is received when the video being played currently is played, and if the pause operation is received when the video being played currently is played, determining the picture of the video being played currently is stopped; or
detecting whether the video being played currently is stuck when the video being played currently is played, and if the video being played currently is stuck when the video being played currently is played, determining the picture of the video being played currently is stopped.

25. The method of claim 24, wherein the obtaining the target watermark corresponding to the video logo and the watermark information of the target watermark from the preset server comprises:
generating a watermark obtaining request comprising the video logo;
sending the watermark obtaining request to the preset server; and
receiving the target watermark corresponding to the video logo and the watermark information of the target watermark which are sent by the preset server.

26. The method according to claim 25, wherein the displaying the target watermark on the picture of the video being played currently comprises:
extracting the watermark format and the display information of the target watermark from the watermark information;
determining a display position, display time and a display duration of the target watermark according to the display information; and
overlappingly displaying the target watermark corresponding to the watermark format on the picture of the video being played currently according to the display position, the display time and the display duration.

27. A non-volatile computer-readable medium containing or processing computer executable instructions that, when executed via one or more processors associated with an electronic device, cause the electronic device to:
obtain a video logo of a video being played currently;
obtain a target watermark corresponding to the video logo and watermark information of the target watermark from a preset server, the watermark information comprising a watermark format and display information; and
display the target watermark on a picture of the video being played currently according to the watermark information.

28. The non-volatile computer-readable medium according to claim 27, wherein the obtaining the target watermark corresponding to the video logo and the watermark information of the target watermark from the preset server comprises:
generating a watermark obtaining request comprising the video logo;
sending the watermark obtaining request to the preset server; and
receiving the target watermark corresponding to the video logo and the watermark information of the target watermark which are sent by the preset server.

29. The non-volatile computer-readable medium according to claim 27, wherein the displaying the target watermark on the picture of the video being played currently comprises:
extracting the watermark format and the display information of the target watermark from the watermark information;
determining a display position, display time and a display duration of the target watermark according to the display information; and
displaying, in an overlapping manner, the target watermark corresponding to the watermark format on the picture of the video being played currently according to the display position, the display time and the display duration.

30. The non-volatile computer-readable medium according to claim 27, wherein the executed instructions further cause the electronic device to:
detect whether the picture of the video being played currently is stopped; and
execute the step of obtaining the video logo of the video being played currently if the picture of the video being played currently is stopped.

31. The non-volatile computer-readable medium according to claim 30, wherein the determining whether the picture of the video being played currently is stopped comprises:
detecting whether a pause operation is received when the video being played currently is played, and if the pause operation is received when the video being played currently is played, determining the picture of the video being played currently is stopped; or
detecting whether the video being played currently is stuck when the video being played currently is played, and if the video being played currently is stuck when the video being played currently is played, determining the picture of the video being played currently is stopped.

32. The non-volatile computer-readable medium according to claim 27, wherein, the watermark format comprises: one or more of graphics interchange format GIF format, HTML5 format, audio format and link address format.

33. An electronic device, comprising:
at least one processor; and
a memory, communicably connected with the at least one processor for storing instructions executed by the at least one processor,
wherein execution of the instructions by the at least one processor causes the at least one processor to perform processing associated with:
obtaining a video logo of a video being played currently;
obtaining a target watermark corresponding to the video logo and watermark information of the target watermark from a preset server, the watermark information at least comprising: a watermark format and display information; and
displaying the target watermark on a picture of the video being played currently according to the watermark information.

34. The electronic device according to claim 33, wherein the obtaining the target watermark corresponding to the video logo and the watermark information of the target watermark from the preset server comprises:
generating a watermark obtaining request comprising the video logo;
sending the watermark obtaining request to the preset server; and
receiving the target watermark corresponding to the video logo and the watermark information of the target watermark which are sent by the preset server.

35. The electronic device according to claim 33, wherein the displaying the target watermark on the picture of the video being played currently comprises:
extracting the watermark format and the display information of the target watermark from the watermark information;
determining a display position, display time and a display duration of the target watermark according to the display information; and
displaying, in an overlapping manner, the target watermark corresponding to the watermark format on the picture of the video being played currently according to the display position, the display time and the display duration.

36. The electronic device according to claim 33, wherein the executed instructions further cause the at least one processor to perform processing associated with:
detecting whether the picture of the video being played currently is stopped; and
executing the step of obtaining the video logo of the video being played currently if the picture of the video being played currently is stopped.

37. The electronic device according to claim 36, wherein the determining whether the picture of the video being played currently is stopped comprises:
detecting whether a pause operation is received when the video being played currently is played, and if the pause operation is received when the video being played currently is played, determining the picture of the video being played currently is stopped; or
detecting whether the video being played currently is stuck when the video being played currently is played, and if the video being played currently is stuck when the video being played currently is played, determining the picture of the video being played currently is stopped.

38. The electronic device according to claim 33, wherein the watermark format comprises: one or more of graphics interchange format GIF format, HTML5 format, audio format and link address format.
